(19) United States
(12) Patent Application Publication
(10) Pub. No.: US 2001/0030406 A1
(43) Pub. Date: Oct. 18, 2001

(54) Axle/adapter assembly for vehicle suspension and suspension incorporating same

(76) Inventor: William C. Pierce, Muskegon, MI (US)

Correspondence Address: RADER, FISHMAN, GRAUER & MCGARRY PLLC, 171 MONROE AVENUE, N.W., SUITE 600, GRAND RAPIDS, MI, 49503, US

(21) Appl. No.: 09/757,038

(22) Filed: Jan. 9, 2001

Related U.S. Application Data
(63) Continuation of application No. PCT/US00/13612, filed on May 18, 2000.
(60) Provisional application No. 60/135,282, filed on May 21, 1999.

(51) Int. Cl. B60G 9/00

(52) U.S. Cl. 280/124.116; 280/124.1

(57) ABSTRACT

An axle and adapter bracket assembly alone and in combination with a suspension and comprising a lightly compressible spacer between the two for a slight adjustment of the axle with respect to the axle bracket after the weld operation. Preferably, the axle and adapter bracket assembly comprises an axle adapter bracket having an arcuate surface supporting the axle and an axle welded to the axle bracket along longitudinal surfaces of the adapter bracket. A lightly compressible spacer is provided between the adapter bracket and the axle. The lightly compressible spacer is preferably in the form of flexible elastomeric foam tape strips. A compressive connector, such as a U-bolt, can be used to compressively retain the axle to the axle adapter bracket and apply a compressive force that counters the residual tensile stress in the weld.

### RELATED APPLICATIONS

This application claims priority to United States Provisional Patent Application Ser. No. 60/135,282, filed May 21, 1999 and is continuation of PCT International Application No. PCT/US00/13612, filed May 18, 2000.

### BACKGROUND OF THE INVENTION

1. Field of the Invention

This invention relates to suspension systems. In one of its aspects, the invention relates to a vehicle suspension system wherein an axle is welded to an axle adapter bracket and tensile stress in the weld between the axle and the adapter bracket is relieved. In another of its aspects, the invention relates to a suspension system in which an axle is mounted to a trailing arm suspension through an axle adapter bracket. In yet another of its aspects, the invention relates to a method for assembling an axle to an axle adapter bracket for use in a vehicle suspension.

2. Description of the Related Art

Trailing arm suspensions, such as disclosed in the Galazin et al. U.S. Pat. No. 5,112,078, comprise a trailing arm suspension wherein an axle is mounted to a pair of trailing arms, each of which are pivotably mounted to an axle frame at one end through a hanger bracket and resiliently mounted to the axle at another end through an air spring. The axle is typically mounted to the trailing arm suspension through an adapter bracket which includes an arcuate surface to cradle the axle and which is welded to axle. The adapter bracket is in turn mounted to the trailing arm suspension, typically through bushed joints. U-bolts can also be used to secure the axle and adapter bracket to the trailing arm suspension.

Welding of the axle to the adapter bracket tends to create stresses within the axle and in the weld. In particular, the axle expands during the welding operation. The axle and the weld cool after the welding operation. Shrinking of the weld during cooling causes residual tensile stresses in the weld between the axle and the adapter bracket. Previous attempts have been made to solve this problem but without any satisfactory solution.

### SUMMARY OF THE INVENTION

According to the invention, an axle and adapter bracket assembly has a lightly compressible spacer between the two for a slight adjustment of the axle with respect to the axle bracket after the weld operation. Thus, according to the invention, an axle and adapter bracket assembly comprises an axle adapter bracket having an arcuate surface supporting the axle and an axle welded to the axle bracket along longitudinal surfaces of the adapter bracket. According to the invention, a lightly compressible spacer is provided between the adapter bracket and the axle. The lightly compressible spacer is preferably in the form of flexible elastomeric foam tape strips. The lightly compressible spacer, or flexible elastomeric foam tape strips, are positioned on the U-shaped surface of the adapter bracket before mounting the axle onto the adapter bracket. The foam tape remains in place after welding of the axle to the adapter bracket. The lightly compressible spacer is compressed between the axle and the U-shaped surface of the adapter bracket after the welding operation and the weld and axle have cooled. The shrinkage between the axle and the adapter bracket which normally results in residual tensile stresses between the axle and adapter bracket is accommodated by the compression of the compressible spacer. The compressible spacer is typically only slightly compressed by the weight of the axle in the adapter bracket and only compresses significantly upon shrinkage of the weld between the axle and the adapter bracket.

A compressive connector can be used to compressively connect the axle to the axle adapter bracket. The compressive connector applies a compression force to the weld that counters the residual tensile stress in the weld. The magnitude of the compressive force can be great enough to overcome the residual tensile stress in the weld and create a residual compressive force in the weld.

In another aspect, the invention relates to a trailing arm suspension comprising a pair of arms adapted to be pivotally mounted at one end to a vehicle frame with springs spaced from the one end of the arm resiliently supporting the arms for resilient movement with respect to a vehicle frame. Axle adapter brackets are mounted to the arms and an axle welded to the axle adapter brackets. A lightly compressible spacer is positioned between the axle adapter bracket and the axle, whereby post-welding shrinkage between the axle and the axle adapter bracket which normally results in residual tensile stresses between the axle and axle adapter bracket is accommodated by the compression of the compressible spacer.

In yet another aspect, the invention relates to a method for mounting an axle to an axle adapter bracket for use in a vehicle suspension system comprising the steps of: positioning a lightly compressible spacer between the axle and the axle adapter bracket; welding the axle to the axle adapter bracket and thereby heating the axle and axle adapter bracket, at least in the area of the weld; and cooling the axle and axle adapter bracket while compressing the lightly compressible spacer between the axle adapter bracket and the axle to accommodate post-welding shrinkage between the axle and axle adapter bracket. The method can further include the application of a compressive force between the axle and the axle adapter bracket to apply a compressive force to the weld. The compressive force can be great enough to overcome the residual tensile stress in the weld and even create a compressive stress in the weld.

### DESCRIPTION OF THE DRAWINGS

The invention will now be described with reference to the accompanying drawings in which:

FIG. 1 is a perspective view of a suspension system according to the invention as mounted on a vehicle frame;

FIG. 2 is a perspective view of one of sides of the suspension system shown in FIG. 1;

FIG. 3 is a perspective view of an axle and axle mounting assembly shown in FIGS. 1 and 2; and

FIG. 4 is a perspective view of an axle adapter bracket shown in the suspension systems of FIGS. 1-3.

### DESCRIPTION OF THE PREFERRED EMBODIMENTS

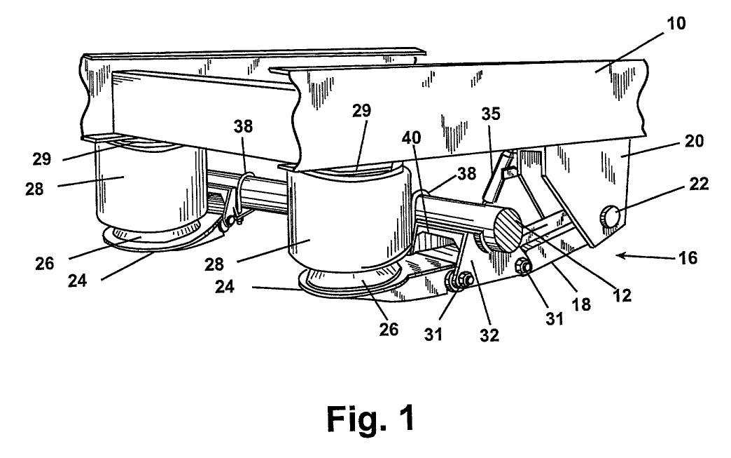

Referring now to the drawings and to FIG. 1 in particular, a vehicle frame 10 has an axle 12 suspended therefrom by a suspension system 16 according to the invention. The front of the vehicle is to the right side of the frame as seen in FIG. 1. Suspension 16 includes, at each side of the vehicle frame 10, a trailing arm 18 pivotally mounted to a frame bracket 20 depending from the frame 10 at a pivotal mount 22. Each trailing arm 18 extends rearwardly of the vehicle frame 10 and away from its pivotal mount 22 in a direction that is longitudinal of the vehicle frame 10. Each trailing arm has an extension 24 that mounts a pedestal 26 of an air spring 28. A top mounting plate 29 of the air spring 28 is secured to the vehicle frame 10. A pair of shock absorbers 35 is pivotally attached between the trailing arm 18 and an upper portion of the frame bracket 20. Axle 12 is connected to each trailing arm 18 through an axle adapter bracket 30 and bushed connections 31.

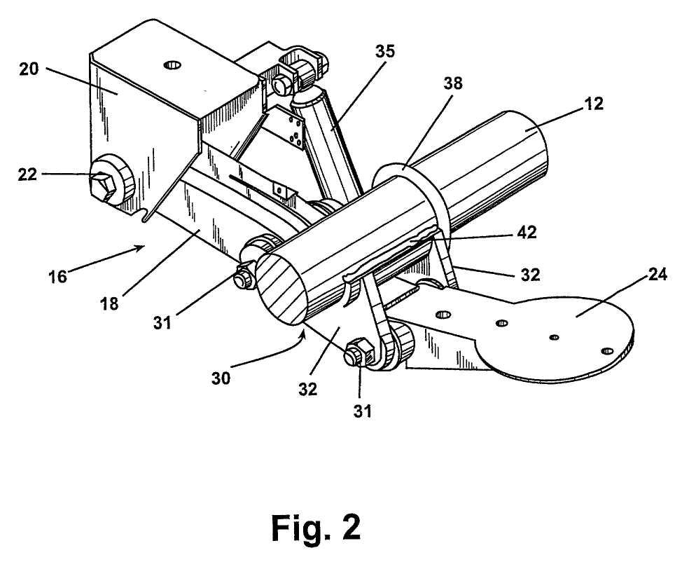

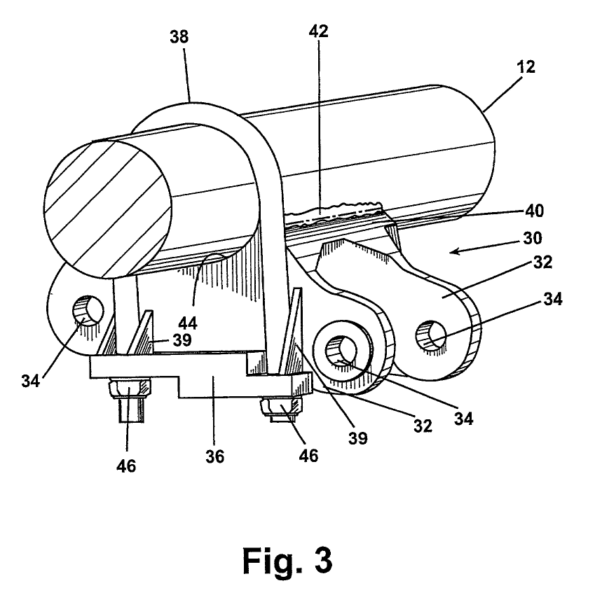

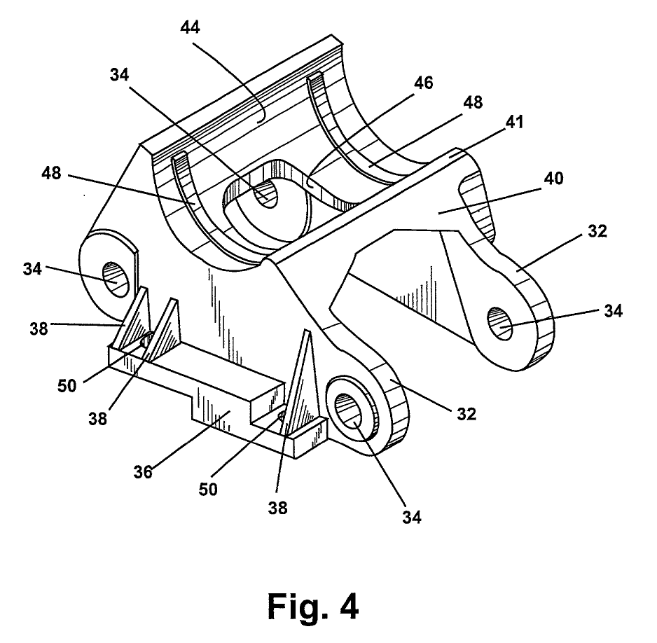

As shown in FIGS. 2 and 3, the axle adapter bracket 30 comprises a pair of mounting plates 32, each having a pair of openings that receive the bushed connection 31. The inner mounting plate 32 has a horizontal attaching flange 36 through which a compressive connector, such as U-bolt 38, compressively retains the axle to the axle adapter bracket. The U-bolt is secured through nuts 46 which thread onto the ends of the U-bolt 38 in conventional fashion. Gussets 39 are secured between the inner mounting plate 32 and the attaching flange 36, preferably by welding, to reinforce the attaching plate 36. A lateral brace 40 extends between the mounting plates 32 at an upper portion thereof and defines a welding surface 41 (FIG. 4). The axle 12 is welded to the adapter 30 through a weld bead 42 which extends along surface 41 and longitudinally along the axle 12 on each side of the adapter. The adapter further has a U-shaped plate 44 having a central opening 46 as illustrated in FIG. 4.

As shown in FIG. 4, a pair of flexible elastomeric foam tape strips 48 is mounted circumferentially on the surface of the U-shaped mounting plate 44 to resiliently space the axle 12 from the interior surface of the mounting plate 44. The foam tape 48 can be single- or double-sided flexible foam tape as, for example, manufactured by 3M. The foam tape is strong enough to space the axle from the interior surface of the U-shaped plate 44 when the axle is cradled within the U-shaped plate 44 and before welding of the axle to the U-shaped plate 44. It is desirable to adhere the tape only to the interior surface of the U-shaped plate 44.

During welding of the axle 12 to the axle adapter bracket 30, the axle and perhaps portions of the axle adapter bracket U-shaped plate 44 will expand somewhat due to the heat of the welding. As the weld cools, the axle, weld and perhaps portions of the U-shaped plate 44 will shrink and create residual tensile stress in the weld between the axle and the adapter. However, as a result of the foam tape spacing, the axle can move closer to the inside surface of the U-shaped plate 44, thereby relieving or reducing the residual tensile stress in the weld. The residual tensile stress in the weld 42 resulting from shrinkage of the axle during cooling is significantly minimized by the use of the foam tape.

In addition to the foam tape, the U-bolt also helps to further relieve or reduce the residual tensile stress in the weld because the U-bolt applies a compressive force to the weld that counters the residual stress in the weld. The residual tensile stress in the weld draws the axle toward the axle adapter bracket against the foam to compress the foam and reduce the residual tensile stress. However, the foam tape is still capable of further compression since the residual tensile stress does not fully compress the foam. The tightening of the U-bolt further draws the axle toward the axle adapter bracket to further reduce the residual tensile stresses in the weld. The U-bolt can be tightened a sufficient amount such that the compressive force applied by the U-bolt to the weld will overcome the residual tensile stress and even create a compressive stress in the weld.

It has been found that the durability of the axle increases significantly, up to threefold, as a result of the use of the tape between the axle and the U-shaped plate. The elimination of the residual tensile stress by the compressive force applied by the U-bolt further enhances durability since the weld is much less likely to fail under compression than under tension.

Whereas the invention has been described with reference to a particular axle adapter bracket and an axle, the invention can be used with any type of suspension wherein an axle is welded to an adapter bracket. Thus, the invention is not necessarily limited to trailing arm suspensions, nor to the particular trailing arm suspension disclosed in the specification.

Further, whereas the invention has been described with reference to foam tape which is adhesively secured to the arcuate plate 44, any type of lightly compressible spacer can be used between the arcuate plate and the axle. Resilient elastomeric strips or even elastomeric sheets can be positioned in the arcuate plate 44 before the axle 12 is positioned therein so long as the spacer compressibly yields upon cooling of the weld. Likewise, other compressive connectors than a U-bolt can be used to compressively retain the axle to the axle adapter bracket.

Reasonable variation and modification are possible within the scope of the foregoing disclosure and drawings without departing from the spirit of the invention.

What is claimed is:

1. An axle adapter and bracket assembly comprising:
an axle adapter bracket for supporting an axle;
an axle welded to the axle adapter bracket; and
a lightly compressible spacer between the axle adapter bracket and the axle;
whereby post-welding shrinkage between the axle and the axle adapter bracket which normally results in residule tensile stresses in the weld between the axle and the axle adapter bracket is accommodated by the compression of the compressible spacer.

2. An axle and adapter bracket assembly according to claim 1 wherein the lightly compressible spacer comprises a flexible elastomeric foam sheet material.

3. An axle and adapter bracket assembly according to claim 2 wherein the flexible elastomeric foam sheet material is adhesively secured to the axle adapter bracket.

4. An axle and adapter bracket assembly according to claim 3 wherein the compressible spacer is substantially uncompressed by the weight of the axle in the axle adapter bracket and is compressed upon shrinkage between the axle and the axle adapter bracket after the welding operation.

5. An axle and adapter bracket assembly according to claim 1 wherein the axle is welded to the axle adapter bracket along longitudinal surfaces of the axle adapter bracket.

6. An axle and adapter bracket assembly according to claim 1 wherein the compressible spacer is substantially uncompressed by the weight of the axle in the axle adapter bracket and is compressed upon shrinkage between the axle and axle adapter bracket after the welding operation.

7. An axle and adapter bracket assembly according to claim 1 wherein the compressible layer comprises multiple strips of a thin layer of an elastomeric material.

8. An axle and adapter bracket assembly according to claim 1, and further comprising a compressive connector that compressively mounts the axle to the axle adapter bracket whereby the compressive mounting of the axle to the axle adapter applies a compressive force to the weld in opposition to the residual tensile stress in the weld.

9. An axle and adapter bracket assembly according to claim 8 wherein compressive connector applies a compressive force to the weld of a magnitude sufficient to counter the residual tensile stress in the weld and create a compressive stress in the weld.

10. An axle and adapter bracket assembly according to claim 8 wherein the compressive connector is a U-bolt at least partially encircling the axle and connected to the axle adapter bracket.

11. A trailing arm suspension comprising a pair of arms adapted to be pivotally mounted at one end to a vehicle frame and mounting springs spaced from the one end of the arm for resiliently supporting the arms for resilient movement with respect to a vehicle frame; axle adapter brackets mounted to the arm; and an axle welded to the axle adapter brackets and extending between the arms; the improvement which comprises:
a lightly compressible spacer between the axle adapter bracket and the axle;
whereby post-welding shrinkage between the axle and the axle adapter bracket which normally results in tensile stresses in the weld between the axle and axle adapter bracket is accommodated by the compression of the compressible spacer.

12. A trailing arm suspension according to claim 11 wherein the lightly compressible spacer comprises a flexible elastomeric foam sheet material.

13. A trailing arm suspension according to claim 12 wherein the flexible elastomeric foam sheet material is adhesively secured on a surface of the axle adapter bracket.

14. A trailing arm suspension according to claim 13 wherein the compressible spacer is substantially uncompressed by the weight of the axle in the axle adapter bracket and is compressed upon shrinkage between the axle and the axle adapter bracket after the welding operation.

15. A trailing arm suspension according to claim 11 wherein the axle is welded to the axle adapter bracket along longitudinal surfaces of the axle adapter bracket.

16. A trailing arm suspension according to claim 11 wherein the compressible spacer is substantially uncompressed by the weight of the axle in the axle adapter bracket and is compressed upon shrinkage between the axle and the axle adapter bracket after the welding operation.

17. A trailing arm suspension according to claim 11 wherein the compressible spacer comprises multiple strips of a thin layer of an elastomeric material.

18. A method for mounting an axle to an axle adapter bracket for use in a vehicle suspension system comprising the steps of:
positioning a lightly compressible spacer between the axle and the axle adapter bracket;
welding the axle to the axle adapter bracket and thereby heating the axle and axle adapter bracket, at least in the area of the weld; and
cooling the axle and axle adapter bracket while compressing the lightly compressible spacer between the axle adapter bracket and the axle to accommodate post-welding shrinkage between the axle and axle adapter bracket.

19. A method for mounting an axle to an axle adapter bracket according to claim 18 wherein the lightly compressible spacer comprises a flexible elastomeric foam sheet material.

20. A method for mounting an axle to an axle adapter bracket according to claim 19 wherein the step of positioning the lightly compressible spacer between the axle and the axle adapter bracket comprises adhesively applying strips of the flexible elastomeric foam sheet material to the axle adapter bracket and thereafter placing the axle onto the axle adapter bracket.

21. A method for mounting an axle to an axle adapter bracket according to claim 20 wherein the axle adapter brackets have an arcuate surface and the axle rests on the arcuate surface of the axle adapter bracket.

22. A method for mounting an axle to an axle adapter bracket according to claim 21 wherein the compressible spacer is substantially uncompressed by the weight of the axle in the axle adapter bracket prior to the welding step.

23. A method for mounting an axle to an axle adapter bracket according to claim 22 and further comprising the step of applying a compressive force between the axle and the axle adapter bracket wherein the compressive force is in opposition to the tensile stress in the weld.

24. A method for mounting an axle to an axle adapter bracket according to claim 23 wherein the compressible spacer is further compressed by the compressive force applied by the compressible mount to further accommodate the tensile stress in the weld.

25. A method for mounting an axle to an axle adapter bracket according to claim 24 wherein the magnitude of the compressive force is great enough to overcome the tensile stress in the weld and create a compressive stress in the weld.

26. A method for mounting an axle to an axle adapter bracket according to claim 25 wherein the compressive force is applied by a U-bolt connecting the axle to the axle adapter bracket.

27. A method of mounting an axle to an axle adapter bracket according to claim 18 wherein the step of positioning the lightly compressible spacer between the axle and the axle adapter bracket comprises adhesively applying the compressible spacer to the axle adapter bracket and thereafter placing the axle onto the axle adapter bracket.

28. A method for mounting an axle to an axle adapter bracket according to claim 27 wherein the axle adapter bracket has an arcuate surface and the axle rests on the arcuate surface of the axle adapter bracket.

29. A method for mounting an axle to an axle adapter bracket according to claim 27 wherein the compressible spacer is substantially uncompressed by the weight of the axle in the axle adapter bracket prior to the welding step.

30. A method for mounting an axle to an axle adapter bracket according to claim 18 wherein the compressible layer comprises multiple strips of a thin layer of an elastomeric material.

31. A method for mounting an axle to an axle adapter bracket according to claim 18 wherein the compressible spacer is substantially uncompressed prior to the welding step.

32. A method for mounting an axle to an axle adapter bracket according to claim 18 and further comprising the step of applying a compressive force between the axle and the axle adapter bracket wherein the compressive force is in opposition to the tensile stress in the weld.
